(19) United States
(12) Patent Application Publication
(10) Pub. No.: US 2026/0048413 A1
(43) Pub. Date: Feb. 19, 2026

(54) CAULKING MACHINE

(71) Applicant: TECHWAY INDUSTRIAL CO., LTD., Taichung City (TW)

(72) Inventors: Chih-Hua HSU, Taichung City (TW); Rui Heng LIN, Taichung City (TW); Chih Chin YANG, Taichung City (TW); Sheng Hong YANG, Taichung City (TW)

(21) Appl. No.: 18/809,004

(22) Filed: Aug. 19, 2024

(51) Int. Cl. B05C 17/01

(52) U.S. Cl. CPC B05C 17/0103

(57) ABSTRACT

A caulking machine comprises: a feeding unit with a power source and a push rod, the power source is capable of driving the push rod to reciprocate; an operating member electrically connected with the power source, and can be operated to provide a signal to the feeding unit; a processing unit electrically connected to the operating member and the power source, and capable of sensing a feeding distance of the push rod and storing the feeding distance; a reproduction mode, when switching to the reproduction mode, the processing unit overwrites a reproduction feeding distance of the push rod in the reproduction mode, in subsequent operations in the reproduction mode, the processing unit drives the push rod to reproduce the reproduction feeding distance. Thereby, setting of a specific feeding distance and reproduction operation can be completed in a single model to facilitate user operation.

### FIELD OF THE INVENTION

The invention relates to a caulking machine, more particularly to a caulking machine capable of setting a filling amount and continuously reproducing the filling amount.

### DESCRIPTION OF THE RELATED ART

A conventional caulking machine has a feeding unit, and the feeding unit has a push rod. The push rod can actuate a predetermined distance by being driven by the feeding unit. Pushing a glue can through the push rod can produce a quantitative caulking. In order to repeatedly fill a specific amount of glue, a setting mode and a reproduction mode are respectively provided in the caulking machine. In the setting mode, the user can first drive the push rod of the feeding unit so that the push rod can actuate a predetermined distance, that is, a specific glue filling amount. After the set glue filling amount is completed, the caulking machine is switched to the reproduction mode, the glue filling amount set in the setting mode will be reproduced in the reproduction mode, that is, the glue filling amount set by the user in the setting mode will be continuously reproduced in the reproduction mode. The user will continue to squeeze out a fixed glue filling amount in the reproduction mode.

The setting mode and the reproduction mode of the conventional caulking machine are two different operating modes. They need to be switched back and forth during operation, or different buttons are used to achieve this operation. During the operation, besides the inconvenience of switching operation, the user may forget to switch the setting mode to the reproduction mode, which results in the setting action being repeated; or in the reproduction mode, the user did not perform operation of the setting mode, causing the extrusion amount after pressing the button is the amount of the previous setting mode, which does not match the expected extrusion amount this time, leading to the operational error.

### SUMMARY OF THE INVENTION

A main object of the invention is to provide a caulking machine capable of setting a feeding distance and using the repeated feeding distance in a single reproduction mode, thereby simplifying operating procedures and reducing a probability of misoperation.

In order to achieve the above object, the invention provides a caulking machine comprising:
a main body having a body part and a gripping part, a front end of the body part is provided with a track;
a feeding unit provided in the body part and having a power source and a push rod, the power source is capable of driving the push rod to reciprocate, a front end of the push rod is located in the track, when the power source drives the push rod, the front end of the push rod is capable of displacing linearly in the track;
an operating member, the operating member is electrically connected to the power source and is operated to cause the power source to be driven, so that the power source drives the push rod to feed;
a processing unit is electrically connected to the operating member and the power source, capable of sensing a feeding distance of the push rod and storing the feeding distance, and capable of driving the push rod to feed to reach the feeding distance;
a mode switching member is electrically connected to the processing unit, the mode switching member is switched to cause the processing unit to switch to different modes;
at least one normal mode; and
a reproduction mode, when the caulking machine switches from the normal mode to the reproduction mode, the processing unit overwrites a reproduction feeding distance of the push rod in the reproduction mode, in subsequent operations in the reproduction mode, the processing unit drives the push rod to reproduce the reproduction feeding distance.

Thereby, a user can first set the reproduction feeding distance in the reproduction mode, and then perform repeated operations in the reproduction mode, thereby reducing a probability of operating errors and performing operation continuously without switching modes.

Preferably, the processing unit is electrically connected to a signal sensor, the signal sensor is capable of sensing a signal of a feeding distance of the push rod, and a storage unit capable of storing the signal sensed by the signal sensor and forming the reproduction feeding distance, and the processing unit is also capable of reading the reproduction feeding distance from the storage unit, and then driving the power source and driving the push rod to reproduce the reproduction feeding distance; and capable of detecting a feeding distance at a specific position through the signal sensor to form the reproduction feeding distance, and writing the reproduction feeding distance into the storage unit for storage.

Preferably, further comprising an accumulation operation, when the storage unit stored the reproduction feeding distance, and the operating member is operated to cause the push rod to feed an accumulated distance, the signal sensor senses the accumulated distance; then the accumulation operation is performed, so that the accumulated distance is combined with the reproduction feeding distance to form a new reproduction feeding distance to be stored in the storage unit; a user can increase a feeding distance that is insufficient in a first setting through the accumulation operation.

The invention provides a caulking machine that enables a user to set the reproduction feeding distance of the push rod in a single operation mode by using the reproduction mode, after the reproduction feeding distance is stored by the processing unit, the operating member can be pressed, and continue to reuse the set reproduction feeding distance in the same reproduction mode. In addition to being convenient for use without having to switch between various modes, incorrect use of a last record can be avoided.

### BRIEF DESCRIPTION OF DRAWINGS

The objects, features, and achieved efficacies of the invention can be understood from the description and drawings of the following preferred embodiments, in which:

FIG. 1 is a perspective view of a caulking machine of a first preferred embodiment of the invention.

FIG. 2 is a cross-sectional view of the caulking machine of the first preferred embodiment of the invention.

FIG. 3 is a block diagram of components of the caulking machine of the first preferred embodiment of the invention.

FIG. 4 is a flow chart of a reproduction mode of the first preferred embodiment of the invention.

FIG. 5 is an operation diagram of the reproduction mode of the first preferred embodiment of the invention.

FIG. 6 is a flow chart of the reproduction mode of a second preferred embodiment of the invention.

FIG. 7 is a flow chart of accumulation signals in the reproduction mode of a third preferred embodiment of the invention.

FIG. 8 is a perspective view of the caulking machine of a fourth preferred embodiment of the invention.

FIG. 9 is an appearance diagram of a mode switching member of the fourth preferred embodiment of the invention.

FIG. 10 is a schematic diagram displaying mode switching of the fourth preferred embodiment of the invention.

### DETAILED DESCRIPTION OF THE INVENTION

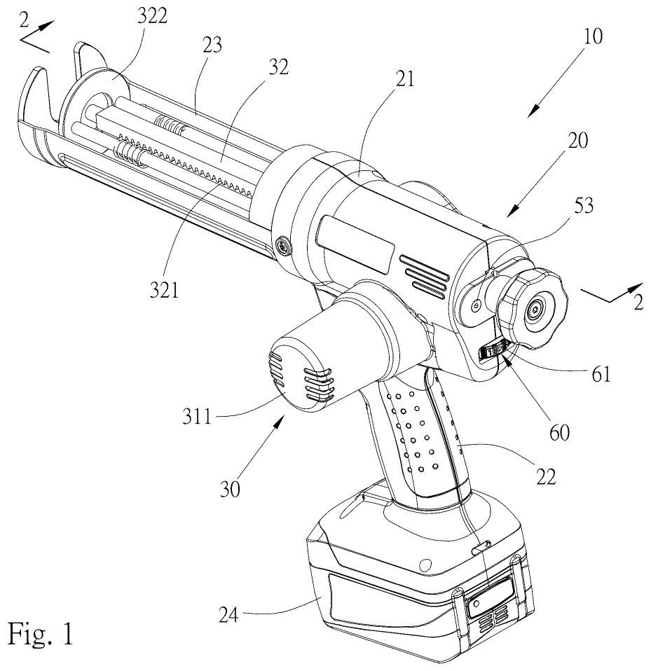

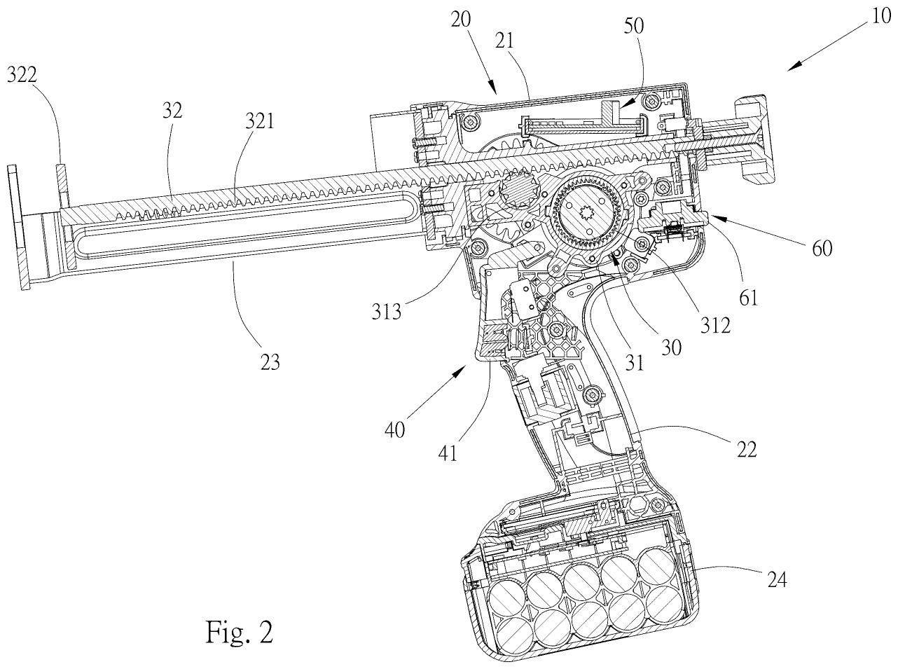

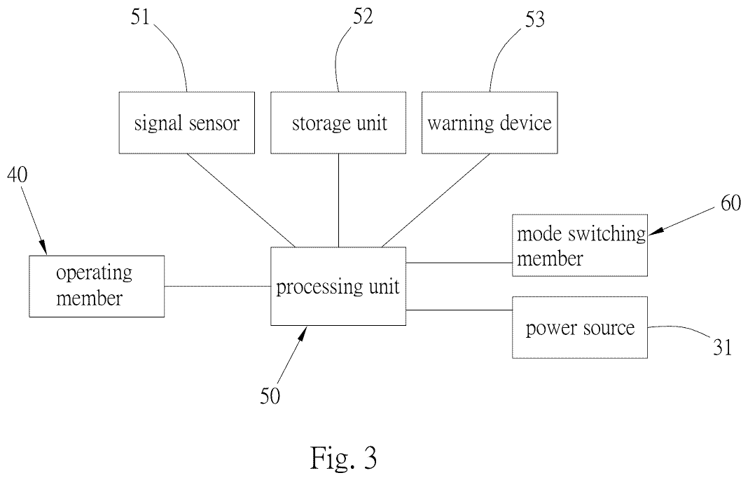

Please refer to FIGS. 1 to 4 for a first preferred embodiment of a caulking machine provided by the invention. A caulking machine 10 comprises following components.

A mail body 20 has a body part 21 and a gripping part 22. A front end of the body part 21 is provided with a track 23; a gun-shaped structure is formed between the body part 21 and the gripping part 22. The gripping part 22 can be held and operated by a user's hand; a bottom of the gripping part 22 is electrically connected to a power unit 24.

A feeding unit 30 is provided in the body part 21 and has a power source 31 and a push rod 32. The power source 31 is composed of a motor 311 and a gear set 312. The gear set 312 has output teeth 313 capable of meshing with the push rod 32. A rack 321 is provided at a bottom of the push rod 32. The rack 321 meshes with the output teeth 313. The power source 31 is capable of driving the push rod 32 to reciprocate. A extrusion head 322 is provided at a front end of the push rod 32 and is located in the track 23. When the power source 31 drives the push rod 32, the extrusion head 322 is capable of displacing linearly in the track 23.

An operating member 40, in this embodiment, is composed of a trigger 41, which is disposed at the front end of the body part 21 and electrically connected to the power source 31 and the power unit 24. The trigger 41 can be operated, that is, pressing the trigger 41 to conduct the motor 311 and the power unit 24, so that the motor 311 of the power source 31 can be driven to drive the gear set 312, and the output teeth 313 can engage the rack 321 to cause the push rod 32 to feed.

A processing unit 50 is disposed in the body part 21 and is electrically connected to the operating member 40 and the power source 31. The processing unit 50 is electrically connected to a signal sensor 51. The signal sensor 51 is capable of sensing a signal of a feeding distance of the push rod 32. In this embodiment, the signal sensor 51 is disposed on a side of the output teeth 313 and is capable of sensing a number of rotating teeth of the output teeth 313 and recording a signal. In addition, the signal sensor 51 is also capable of sensing a number of revolutions of the motor 311 or a number of forward teeth of the rack 321 to be converted into a distance signal. The processing unit 50 is further provided with a storage unit 52 capable of storing a reproduction feeding distance and a plurality of quantitative feeding distances. The reproduction feeding distance can be cleared and overwritten into the storage unit 52, the reproduction feeding distance is formed by writing a signal sensed by the signal sensor 51, and the reproduction feeding distance of the push rod 32 can be reproduced when being operated again. The quantitative feeding distance is a fixed numerical value stored in the storage unit 52. The processing unit 50 is further provided with a warning device 53 composed of a warning light. The processing unit 50 releases the operating member 40 before an operation is completed, so that the processing unit 50 will generate a warning signal to the warning device 53 when the operation is not completed, and the warning device 53 can produce a warning function, that is, a flashing light warning.

A mode switching member 60, in this embodiment, is a turntable 61. The turntable 61 is electrically connected to the processing unit 50. The mode switching member 60 can be switched to provide different modes for the processing unit 50. In this embodiment, a plurality of normal modes and a reproduction mode are provided, and the user can switch between different modes by rotating the turntable 61. The normal modes further comprise a continuous mode and a plurality of quantitative modes.

The following describes operation methods of various modes.

In the continuous mode, an operation process will depend on pressing of the operating member 40. When the user presses the operating member 40, the processing unit 50 will drive the power source 31 to rotate, so that the output teeth 313 are capable of rotating to drive the rack 321 to cause the push rod 32 to push forward. The extrusion head 322 is used to squeeze a glue can located on the track 23, and the power source 31 is continuously driven until the user releases the operating member 40. After the operating member 40 is released, the power source 31 will stop rotating, and the push rod 32 will stop feeding.

In the quantitative modes, the quantitative feeding distances stored in the storage unit 52 will be selected. When the mode switching member 60 switches to a quantitative position in a specific quantitative mode (such as 5 ml, 10 ml), the processing unit 50 will also be provided with a relative quantitative feeding distance by the storage unit 52. When the operating member 40 is pressed, the processing unit 50 will drive the power source 31 to operate and sense through the signal sensor 51. When a signal (such as a number of teeth of the output teeth 313 or a number of revolutions of the motor 311) sensed by the signal sensor 51 reaches a numerical value of the quantitative feeding distance, the processing unit 50 will stop driving the power source 31 to operate. Even if the user still presses the operating member 40, the power source 31 will not produce any rotation. The user needs to release the operating member 40 and then repeat the pressing action before the processing unit 50 will drive the power source 31 again, causing the power source 31 to operate to reach the quantitative feeding distance again, that is, in the quantitative mode, the push rod 32 is provided with a fixed feeding distance each time, so that the push rod 32 stops after squeezing a certain amount of glue from the glue can. The user can first select the quantitative mode with the specific quantitative feeding distance according to an amount of extruded glue required to operate.

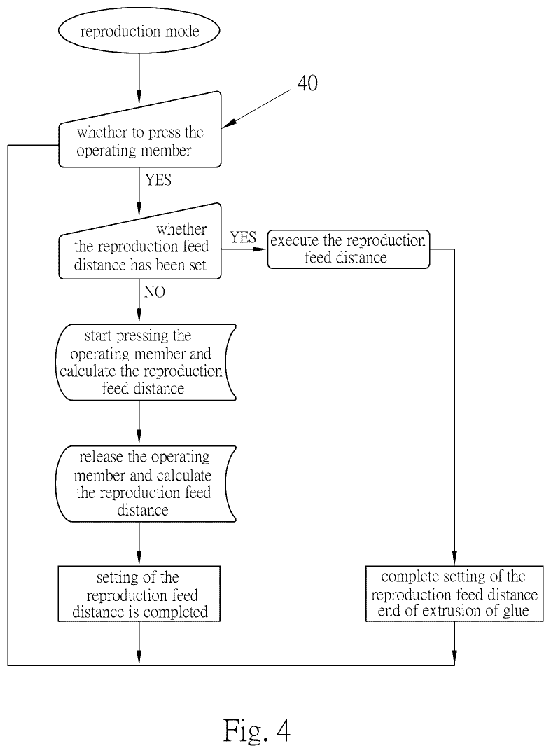

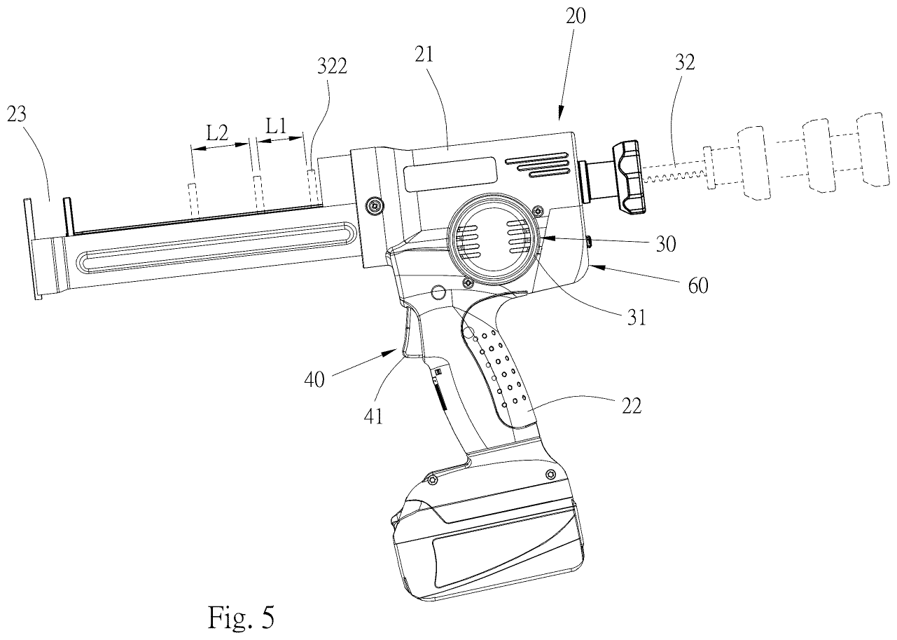

Please refer to FIGS. 4 and 5 for the reproduction mode. When the mode switching member 60 switches to the reproduction mode, the reproduction feeding distance originally stored in the storage unit 52 will be cleared. When the user presses the operating member 40 for a first time in the reproduction mode, the processing unit 50 will drive the power source 311 to make the push rod 32 continue to feed. The signal sensor 51 is capable of generating a signal recording action, a first feeding distance of the push rod 32 recorded in the reproduction mode is a reproduction feeding distance L1, and then the processing unit 50 stores the reproduction feeding distance L1 into the storage unit 52. In the subsequent reproduction mode, as long as the user continues to operate the operating member 40, the processing unit 50 will give a same signal to the power source 31 according to the reproduction feeding distance in the storage unit 52, enabling the user to continuously reproduce the reproduction feeding distance for the push rod 32 of a first operation by the user in the reproduction mode. Thereby, the user is capable of continuously reproducing a feed amount of operating the push rod 32 the first time as a reproduction feeding distance L2, which is a fixed feed amount of the glue can. During the first operation, as long as the operating member 40 is released, the processing unit 50 will directly record the reproduction feeding distance L1 into the storage unit 52. The operation is simple and does not require additional operations for record confirmation. When the reproduction feeding distance L2 is used again, there is no need to switch to other operation modes. Operation can be performed in the reproduction mode, and the operation is simple. In addition, because switching to the reproduction mode each time, the last reproduction feeding distance in the storage unit 52 will be overwritten, the user will not use the last reproduction feeding distance to avoid misoperation.

In addition, in the quantitative mode or the reproduction mode, when the user has not completed an operation, that is, the quantitative feeding distance or the reproduction feeding distance of the push rod 32 has not completed an operation (an amount of glue extruded is insufficient), when the user releases the operating member 40, the processing unit 50 will generate a warning signal to the warning device 53, so that the warning device 53 can generate a light warning to let the user know that the operation has not been completed. After pressing the operating member 40 again, the processing unit 50 will re-drive the quantitative feeding distance or the reproduction feeding distance, enabling the push rod 32 to perform operation of the other new quantitative feeding distance or the other new reproduction feeding distance.

Thereby, when using the caulking machine 10, the user can hold the gripping part 22 with one hand and use the other hand to select a mode through the mode switching member 60. After the mode selected by the mode switching member 60 is determined, the hand holding the gripping part 22 is used to trigger the trigger 41 of the operating member 40, enabling the user to switch according to different locations and operating requirements.

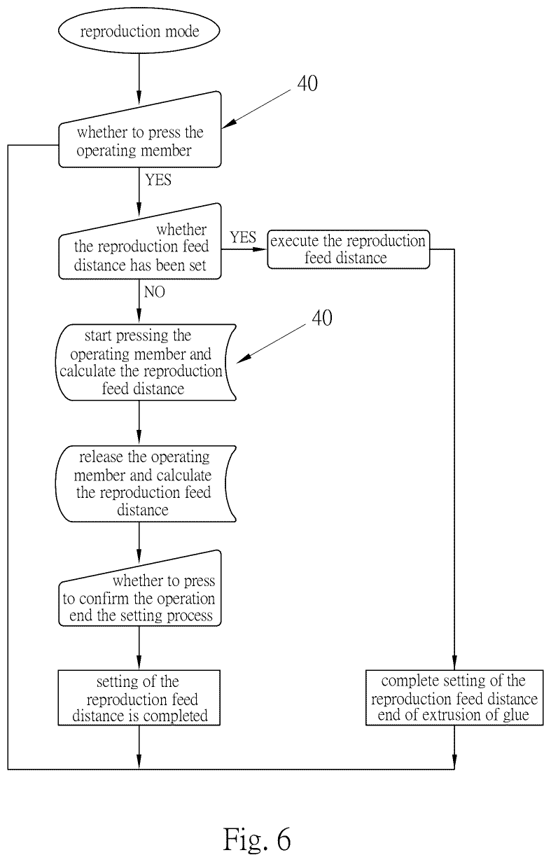

Please refer to FIG. 6 for a second preferred embodiment provided by the caulking machine 10 of the invention. Its main structure is the same as that of the previous preferred embodiment. The same components are represented by the same numerals and will not be described again.

In order to prevent the user from not being able to set an optimal feeding distance due to premature or late release of the operating member 40 in the reproduction mode, and in order that the reproduction feeding distance can be set as the optimal reproduction feeding distance, a confirmation operation can be input after the operating member 40 completes a pressing action. In the confirmation operation in this embodiment, the operating member 40 is repeatedly pressed twice. After the processing unit 50 receives the confirmation operation, the reproduction feeding distance is written into the storage unit 52. In this way, the reproduction feeding distance will not be performed until the operating member 40 is pressed next time.

In addition to repeatedly pressing the operating member 40, the main body 20 can also be provided with a button. After the user presses the button, the confirmation operation is generated. Thereby, the reproduction feeding distance operated by the operating member 40 this time can be written into the storage unit 52 for storage.

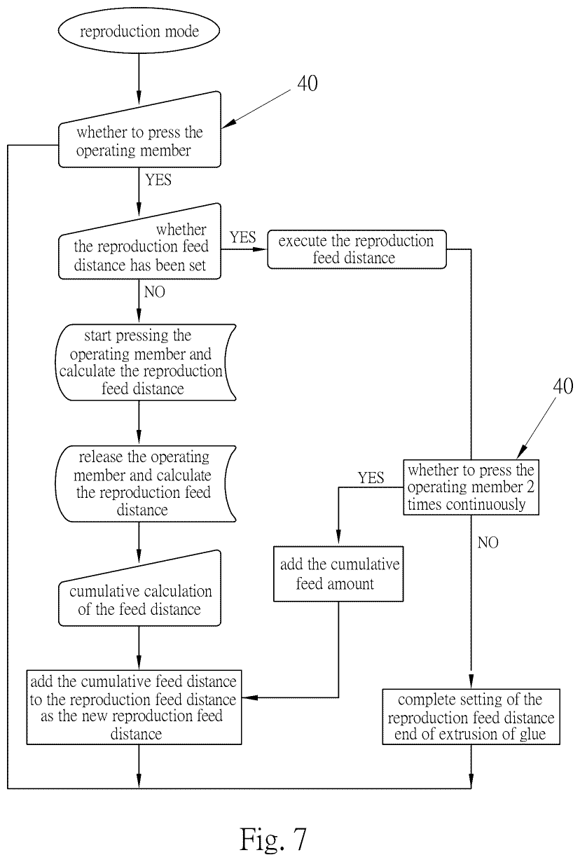

Please refer to FIG. 7 for a third preferred embodiment provided by the caulking machine 10 of the invention. Its main structure is the same as that of the previous preferred embodiment. The same components are represented by the same numerals and will not be described again.

In the reproduction mode, if the user feels that the reproduction feeding distance input into the storage unit 52 after pressing the operating member 40 for a first time is insufficient, the user can press the operating member 40 again. At this time, when the operating member 40 is pressed, the processing unit 50 will output the reproduction feeding distance, that is, it will stop after the operating member 40 is pressed to reach the set reproduction feeding distance. At this time, only if a position to be accumulated is reached, an accumulation operation is input. In this embodiment, the operating member 40 is released after the operating member 40 is pressed for a second time to complete an accumulated distance, and the operating member 40 is pressed twice repeatedly, so that an accumulated feeding distance sensed by the signal sensor 51 when the operating member 40 is pressed for the second time will be added to the original reproduction feeding distance and become the new reproduction feeding distance, that is, the first reproduction feeding distance added to the accumulated feeding distance when the operating member 40 is pressed for the second time are combined to form the new reproduction feeding distance, so that when the operating member 40 is pressed for a third time, the processing unit 50 will provide the new reproduction feeding distance to form an operation of feeding distance, resulting in a new amount of extruded glue.

In addition, the accumulation operation can also be generated through a button provided on the main body 20. After the user presses the operating member 40 for the second time, and then the user presses the button, the accumulation operation is generated through the button.

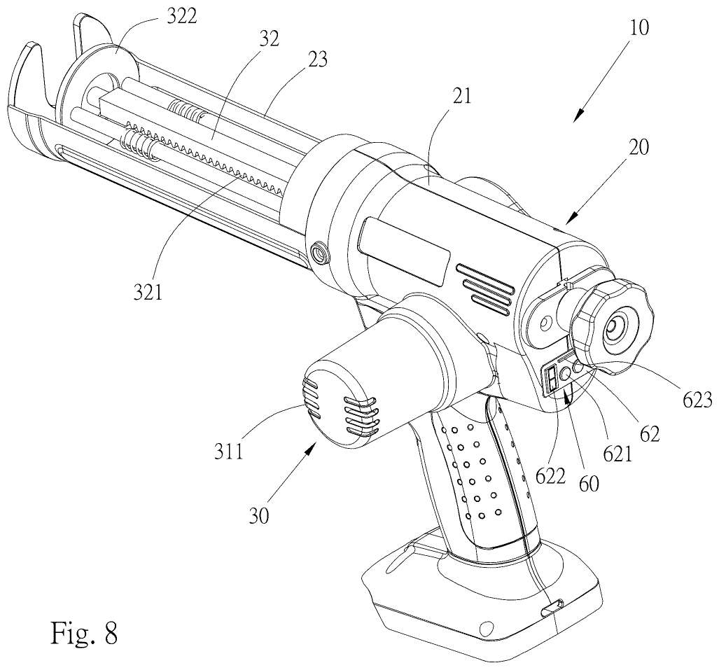

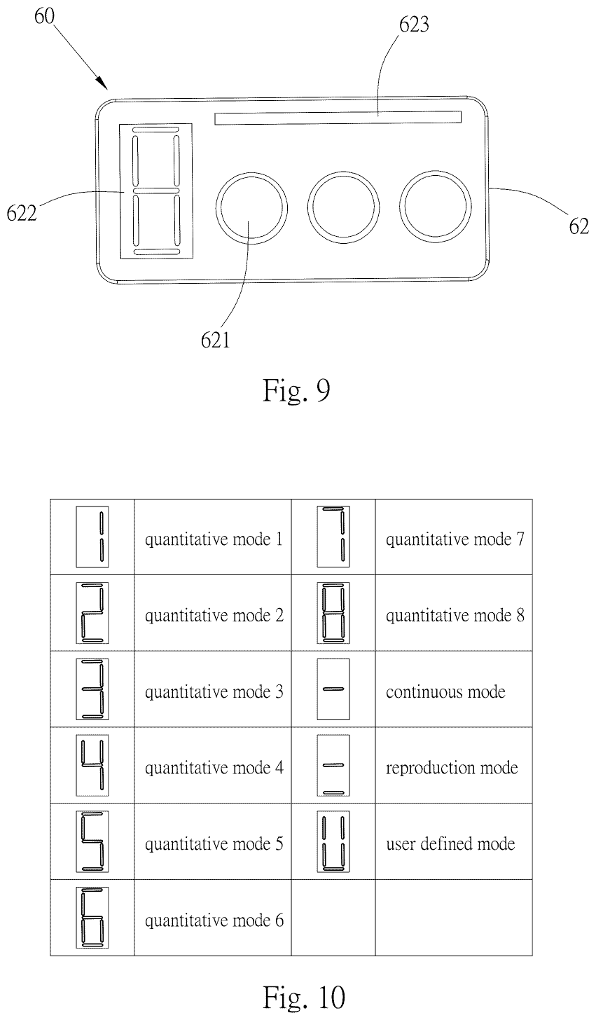

Please refer to FIGS. 8 to 10 for a fourth preferred embodiment provided by the caulking machine 10 of the invention. Its main structure is the same as that of the first preferred embodiment. The same components are represented by the same numerals and will not be described again.

The mode switching member 60 is composed of a human-machine interface 62. The human-machine interface 62 comprises an operation button 621, a display screen 622 and a light-emitting element 623. The human-machine interface 62 is electrically connected to the processing unit 50, the operation button 621 can cause an operation mode switching by being pressed, and can switch an operation mode cyclically, and provide a switching mode display through the display screen 622. As shown in FIG. 10, numbers of the quantitative modes (1-8) can be switched downwards in sequence. Different numbers show different volumes of extruded glue, and then switch to the continuous mode (□), the reproduction mode (□) and a user defined mode(U). Then pressing the operation button 621 will switch to the quantitative mode selection. Use of the operation button 621 enables the user to quickly switch modes by pressing, and confirm an operation mode through the display screen 622. In addition, in the user defined mode (U), data of an operation mode can be transmitted to the storage unit 52 of the processing unit 50 for storage through external signals, such as WIFI, Bluetooth, Internet of Things (IoT) of wireless or wired transmission methods. In addition, in order to ensure that mode switching is correct, the processing unit 50 is capable of driving the light-emitting element 623 after confirming an operation of the operation button 621, so that the light-emitting element 623 can be used as a confirmation signal or other indication functions; the confirmation signal can also be displayed directly through the display screen 622, or through other methods that enable the user to receive notifications.

Operation of the reproduction mode of the caulking machine provided by the invention can be carried out in a single mode, operation is simple and does not require switching, making it convenient for the user to operate; compared with the conventional operation mode that requires switching between writing and reproduction, in addition to being more difficult to use, it is also easy to forget a previous stored content during switching, resulting in misoperation. The reproduction mode of the invention can first establish basic signals during each switching process, and then perform storage and reproduction, operation is simple and it is not easy to cause misoperation.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is

1. A caulking machine comprising:
a main body having a body part and a gripping part, a front end of the body part being provided with a track;
a feeding unit provided in the body part and having a power source and a push rod, the power source being capable of driving the push rod to reciprocate, a front end of the push rod being located in the track, when the power source driving the push rod, the front end of the push rod being capable of displacing linearly in the track;
an operating member, the operating member being electrically connected to the power source and being operated to cause the power source to be driven, so that the power source driving the push rod to feed;
a processing unit electrically connected to the operating member and the power source, capable of sensing a feeding distance of the push rod and storing the feeding distance, and capable of driving the push rod to feed to the feeding distance;
a mode switching member electrically connected to the processing unit, the mode switching member being switched to cause the processing unit to switch to different modes;
at least one normal mode; and
a reproduction mode, when the caulking machine switching from the normal mode to the reproduction mode, the processing unit overwriting a reproduction feeding distance of the push rod in the reproduction mode, in subsequent operations in the reproduction mode, the processing unit driving the push rod to reproduce the reproduction feeding distance.

2. The caulking machine as claimed in claim 1, wherein the processing unit is electrically connected to a signal sensor, the signal sensor is capable of sensing a signal of a feeding distance of the push rod, and a storage unit capable of storing the signal sensed by the signal sensor and forming the reproduction feeding distance, and the processing unit is also capable of reading the reproduction feeding distance from the storage unit, and then driving the power source to drive the push rod to reproduce the reproduction feeding distance.

3. The caulking machine as claimed in claim 2, wherein a signal sensed by the signal sensor is a rotation angle of the power source.

4. The caulking machine as claimed in claim 2, wherein a signal sensed by the signal sensor is a moving distance of the push rod.

5. The caulking machine as claimed in claim 2, further comprising an accumulation operation, when the storage unit having the reproduction feeding distance, and the operating member being operated to cause the push rod to feed an accumulated distance, the signal sensor sensing the accumulated distance; then the accumulation operation being performed, so that the accumulated distance being combined with the reproduction feeding distance to form a new reproduction feeding distance to be stored in the storage unit.

6. The caulking machine as claimed in claim 5, wherein the accumulation operation can be formed by triggering the operating member at least twice continuously.

7. The caulking machine as claimed in claim 5, further comprising a button, triggering the button being capable of forming the accumulation operation.

8. The caulking machine as claimed in claim 1, wherein the normal mode comprises a continuous mode and at least one quantitative mode; in the continuous mode, the operating member is capable of continuously driving the power source so that the push rod is capable of moving continuously; in the quantitative mode, when the operating member is triggered, the processing unit is capable of driving the power source to operate to reach a fixed position, so that the push rod is capable of actuating a fixed distance; when the normal mode has the quantitative modes, the different quantitative modes have different fixed distances.

9. The caulking machine as claimed in claim 1, further comprising a confirmation signal, only after receiving the confirmation signal, the processing unit storing the reproduction feeding distance.

10. The caulking machine as claimed in claim 9, wherein triggering the operating member at least twice continuously is capable of forming a confirmation operation.

11. The caulking machine as claimed in claim 9, further comprising a button, triggering the button being capable of forming the confirmation operation.

12. The caulking machine as claimed in claim 1, wherein the processing unit is further electrically connected to a warning device, when a feeding distance of the push rod of the feeding unit does not reach the reproduction feeding distance, the processing unit generates a warning signal to the warning device.

13. The caulking machine as claimed in claim 1, wherein the mode switching member comprises a turntable, changes in a rotation position of the turntable are capable of controlling the processing unit to switch to different modes.

14. The caulking machine as claimed in claim 1, wherein the mode switching member comprises a human-machine interface, the human-machine interface has at least one operation button and a display screen, the operation button is capable of controlling the processing unit to switch to different modes.
